(19) United States
(12) Patent Application Publication
(10) Pub. No.: US 2014/0183148 A1
(43) Pub. Date: Jul. 3, 2014

(54) Magnetic Cookware Stands

(71) Applicant: Allure Home Creation Co., Inc., (US)

(72) Inventor: Edward Ho, Warren, NJ (US)

(73) Assignee: ALLURE HOME CREATION CO., INC., Boonton, NJ (US)

(21) Appl. No.: 13/729,809

(22) Filed: Dec. 28, 2012

(51) Int. Cl. A47J 47/16

(52) U.S. Cl. CPC A47J 47/16
USPC 211/49.1

(57) ABSTRACT

In exemplary embodiments of the present invention various types of magnetic cookware stands are provided, allowing pots, pans and the like to be stored with their diametral dimension in a substantial vertical position, resting on a side. The cookware stands are provided with embedded magnets or magnetic devices, so as to either attach to a bottom surface of a pot or a pan, or to a handle of a pot or a pan. In some exemplary embodiments, a stand can be made up of various magnetically interconnected modular units, each unit able to hold one pan, and a user can configure how many of such units a desired cookware stand comprises. The technology allows such pans to be conveniently stored, without resting upon, or even touching, one another. Because they can be oriented vertically in such exemplary devices, storage space is optimized.

### TECHNICAL FIELD

The present invention relates to efficiently storing cookware to optimize use of kitchen space. In particular, the present invention is directed to various types of magnetic cookware storage stands and devices.

### BACKGROUND OF THE INVENTION

Cookware, such as pots and pans, often presents storage issues. Many people prefer not to store them in plain view within the kitchen, and thus they need to be stored in drawers, cabinets and the like. However, drawers and cabinets typically are not optimized for storage of pans and pots, especially those with a low depth and large diameter. Such cookware, akin to cutting boards and cooking utensils with large flat surfaces are often best stored with each pan oriented vertically.

Additionally, it is important not to let other pans and utensils touch the interior of a given pan. First, it can scratch it, second, if there is a nonstick coating of any kind, such coating is often worn in places where other pans and utensils routinely rest on, or abut, such coated pans during storage. Wear and tear on non-stick coatings is known to introduce differential and non-uniform heating issues, and ultimately can destroy the cookware. These issues would similarly be remedied if cookware was stored so that it was oriented vertically.

To store cookware vertically, the cookware must rest on its side. Unfortunately, pots and pans are not designed to rest on their sides. Often, exemplary pans have the shape of either wide and short cylinders, with a “deep dish” side structure, or are circular or oval shaped, and have sides that curve from a smaller bottom surface up to a larger area at the top of the pot or pan. These latter designs thus have two directions of curvature, both along and normal to the side of such cookware at any point. Thus, as a general rule, cookware has no stable flat surface except for its bottom surface on which they can conveniently be stored. Additionally, even if they could be stored on their sides in some semi-stable equilibrium, the typical long handle attached to them, as shown in FIGS. 1-3, for example, tends to move around, and is not held in a fixed position.

What is needed in the art are apparatus and methods to optimally store cookware so as to remedy the problems of the prior art.

### SUMMARY OF THE INVENTION

In exemplary embodiments of the present invention various types of magnetic cookware stands are provided, allowing pots, pans and the like to be stored with their diametral dimension in a substantial vertical position, resting on a side. The cookware stands are provided with embedded magnets or magnetic devices, so as to either attach to a bottom surface of a pot or a pan, or to a handle of a pot or a pan. In some exemplary embodiments, a stand can be made up of various interconnected modular units, each unit able to hold one pan, and a user can configure how many of such units a desired cookware stand comprises (e.g., one or more). Such modular units are preferentially attached by means of embedded magnets or magnet devices The technology allows such pans to be conveniently stored, without resting upon, or even touching, one another. Because they can be oriented vertically in such exemplary devices, storage space is optimized.

### BRIEF DESCRIPTION OF THE DRAWINGS

FIG. 1 illustrates an exemplary modular cookware stand with curved inner surface according to an exemplary embodiment of the present invention;

FIG. 2 illustrates the exemplary cookware stand of FIG. 1 with a different surface veneer;

FIG. 3 is a frontal view of the exemplary modular cookware stand of FIG. 1 showing two exemplary pans stored within it;

FIG. 4 show right side and perspective frontal views of structural elements used in the exemplary modular cookware stand of FIG. 1;

FIG. 5 shows various views of a single pan and its relationship to a single modular element of the exemplary modular cookware stand of FIG. 1;

FIG. 6 show additional details of two modular elements of the exemplary cookware stand of FIG. 1 as connected;

FIG. 7 show various renderings of modular elements, with detail of the bottom connection plates;

FIG. 8 is a schematic drawing of the single modular element of FIG. 7(b) in an exploded view;

FIG. 9 is a schematic drawing of the rendering shown in FIG. 7;

FIG. 10 shows an alternate exemplary embodiment of a magnetic cookware stand according to exemplary embodiments of the present invention;

FIG. 11 show various views of the exemplary magnetic cookware stand of FIG. 10; and

FIG. 12 shows various views of the exemplary magnetic cookware stand shown in FIG. 10, without any pans so as to see structural details.

FIG. 13 shows an embodiment adapted to hold a pan on each side of the vertical component. Also shown are magnetic attachments for attachment to further modules.

FIG. 14 shows the attachment of two modular units of FIG. 13.

FIG. 15 shows an embodiment of a magnetic attachment for modular units of the invention in a first position.

FIG. 16 shows an embodiment of a magnetic attachment for modular units of the invention in a second position.

FIG. 17 shows an exploded view of an attachment means of an embodiment of the invention.

FIG. 18 shows depicts the engagement of the spring and pin components of FIG. 17.

FIG. 19 depicts the external view of the engaged components of FIG. 17.

FIG. 20 depicts a slidable dowel connection of the present invention.

It is noted that the patent or application file may contain at least one drawing executed in color. If that is the case, copies of this patent or patent application publication with color drawing(s) will be provided by the U.S. Patent and Trademark Office upon request and payment of the necessary fee.

### DETAILED DESCRIPTION OF THE INVENTION

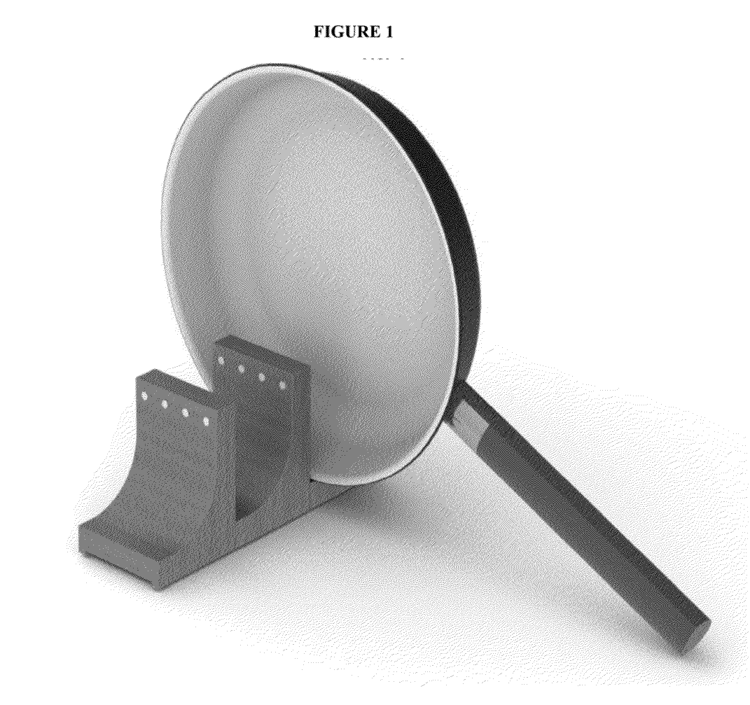

In accordance with exemplary embodiments of the present invention, apparatus can be provided to optimally store cookware, such as, for example, pots and pans. Such pots and pans can include any type, such as frying pans, sauté pans, saucepans and the like, of whatever type and description. A few examples of cookware that can be stored in exemplary storage stands according to the present invention are illustrated in FIGS. 1-3, but are understood as being only exemplary.

Modular Cookware Stand Attachable to Cookware Itself

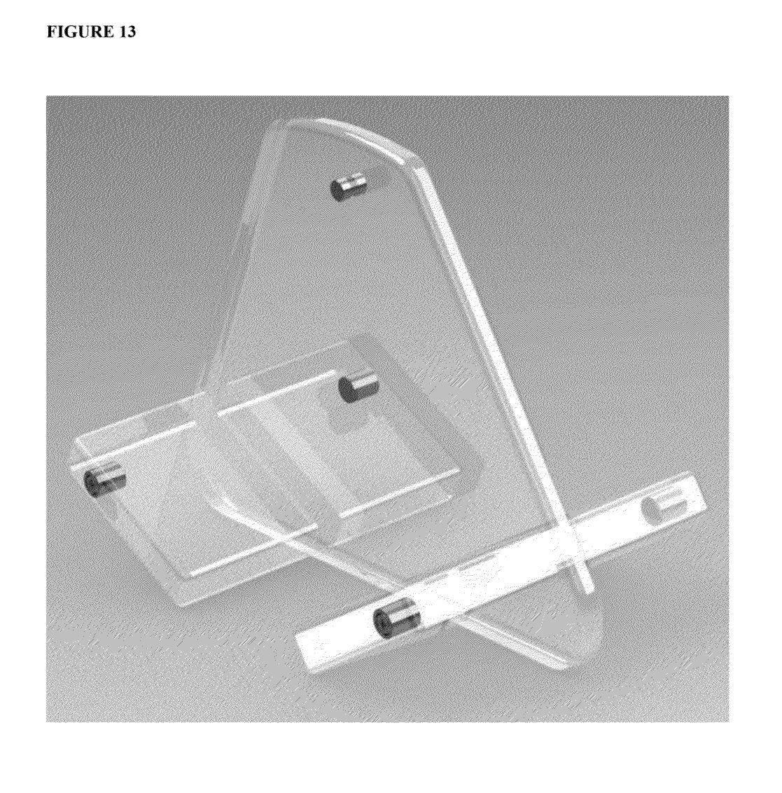

The figures, next described, illustrate exemplary magnetic cookware stands and attachment means according to exemplary embodiments of the present invention. In an exemplary embodiment any number of spaces or cells for pans to be stored can be created, given the modular nature of the exemplary cookware stand, as will be described more fully below. In addition, on one side of each cell, in the illustrated example it is the right side as one looks into the figures, a wall is provided or embedded with a number of magnets (at least one) such as, for example, anywhere from 2 to 4 or more. In the exemplary embodiment depicted in FIGS. 1 through 9 there are 4 magnets embedded in each right wall of each cell of the modular magnetic cookware stand. The magnetics depicted can be of varying sizes (e.g., round, oval square, rectangular, strips, etc.) The magnets can be aligned in any manner such as horizontally as depicted in FIG. 1 or vertically as depicted in FIG. 13, the magnets can also be staggered in an arrangement to engage a pan. These magnets attract the bottom of a ferromagnetic pan which can be a pan made out of a single ferromagnetic material, or, for example, which can be a standard non-ferromagnetic pan, such as, for example aluminum or copper into which a steel or iron, for example, annular ring or plate, or central patch, has been embedded within the bottom surface, thus allowing it to easily be grasped by the embedded magnets.

It is noted that such an embedded ferromagnetic surface should be large enough (either in width, length or diametral dimension, as the case may be) so that various pans of varying diameters can be readily stored in the magnetic cookware stand, and all be grasped by the embedded magnets. In exemplary embodiments of the present invention, an embedded ferromagnetic surface can be, for example, a sheet, annular ring or the like made of stainless steel, and glued, riveted or otherwise fastened to the bottom surface of cookware. For example, such a ferromagnetic surface can be an annular ring or circular shape embedded within the bottom surface of pots and pans, much like copper surfaces are embedded in certain cookware for heat transfer properties. The present invention is also directed to pans with non-ferromagnetic surfaces that have an embedded ferromagnetic material on the bottom surface or near the bottom surface (e.g., exposed or completely embedded) to engage a magnetic pan holder as disclosed herein.

Beginning with reference to FIG. 1, there is shown an exemplary modular cookware stand showing two full cells and one open cell at the far left. Thus, there is a space for 3 pans. As can be seen, the bottom surface of the pan is attached to magnets at the top right of the cell (as seen in the leftmost two empty cells—four silver dots at top of right wall). This allows the exemplary pan to be stored in an upright position, essentially resting on its side and having its long diametral dimension oriented in a vertical plane. This allows for optimization of storage in cabinets and drawers, such as are found in kitchens, and precludes having to stack pans one on top of the other which, as noted, can damage them and create a general lack of order in the pantry or cookware closet. In some embodiments as depicted in FIG. 1A, each single modular unit can hold a pan on each side of the vertical component. These units can also be attached to each other to hold multiple pans.

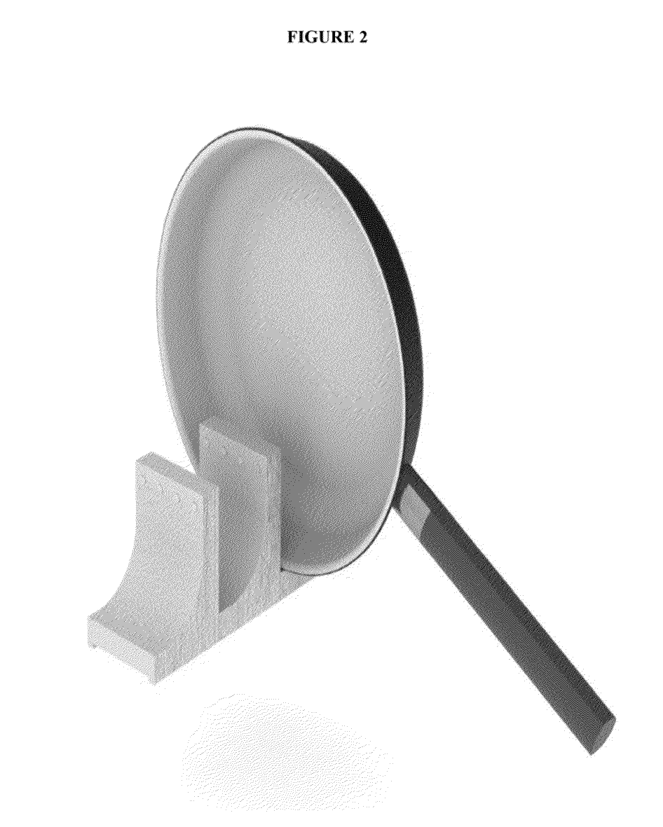

FIG. 2 is an identical device as shown in FIG. 1 with a different outward veneer, but otherwise functionally the same.

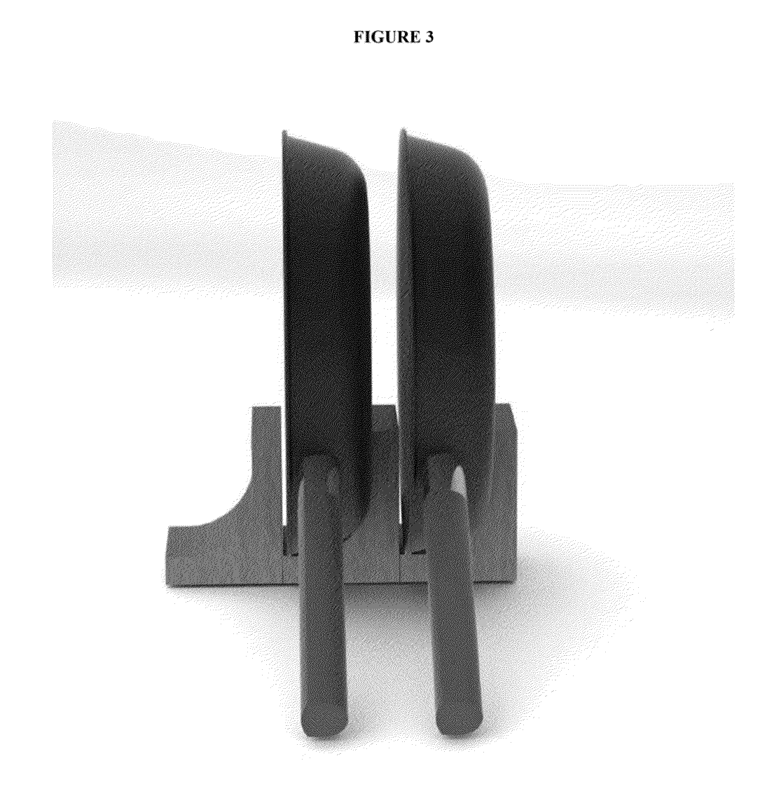

FIG. 3 shows the exemplary cookware stand of FIG. 1 from a head-on frontal view, holding two pans, one in each of the full cells.

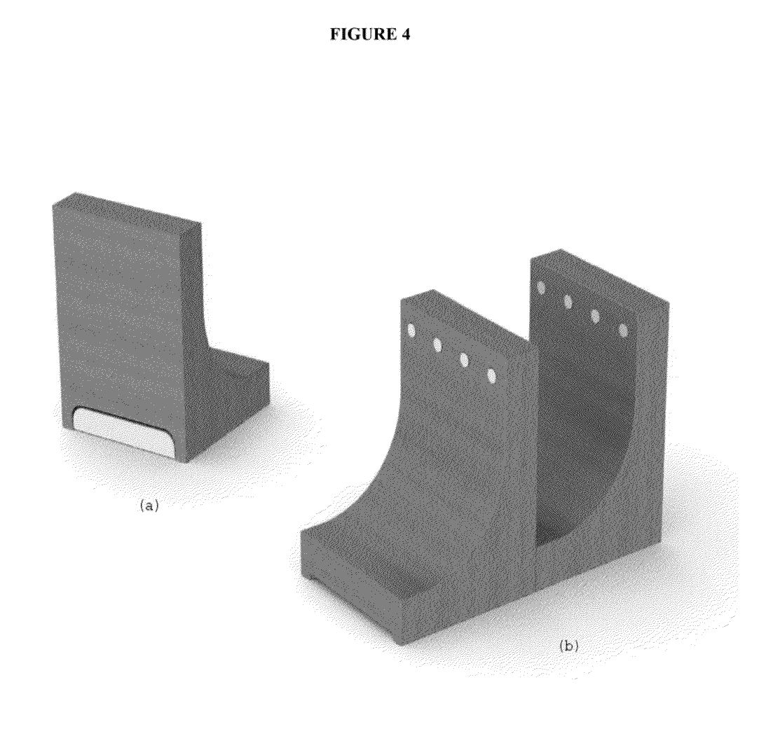

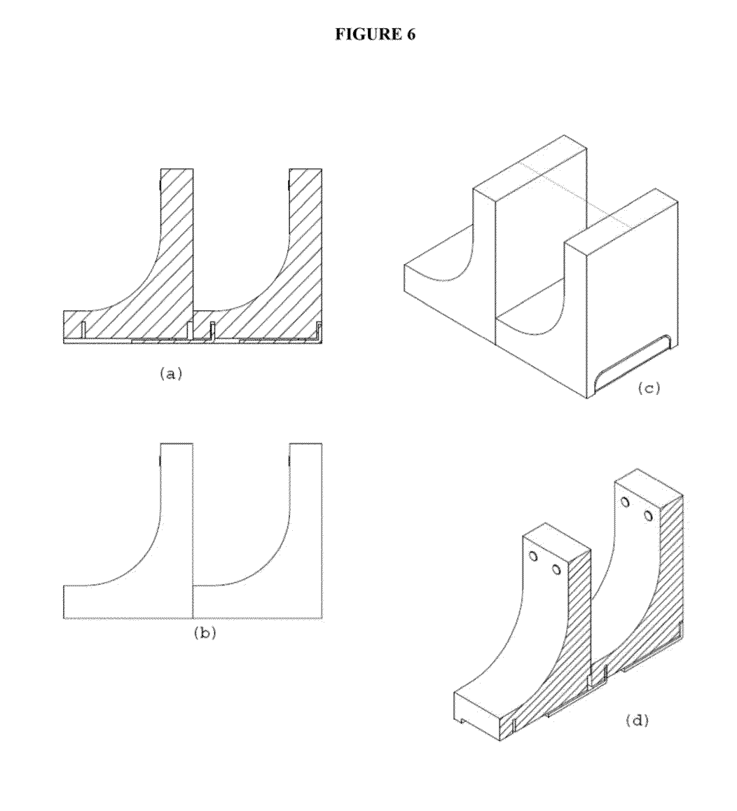

FIG. 4 show details of a modular element of the exemplary cookware stand. As noted, the exemplary cookware stand can be made as large or as small as desired, simply by adding modular structural elements. With reference to FIG. 4(a) there is seen a back view of a modular element, and with reference to FIG. 4(b), two such modular elements are combined to create a closed cell and an open cell. As can be seen in the figures, each modular element is a modified “L” shape, like a book-end, with a horizontal bottom surface and a vertical surface perpendicular to it. A curved transition is provided between the horizontal surface and the vertical one, whose radius of curvature is designed to match or approximate that of various sets of cookware. As also seen in FIG. 4(a), there is an expandable connection plate provided on the underside of the modular element, explained in detail below in connection with FIGS. 6-9. Alternatively, the modular units of FIG. 4 can be attached with embedded magnets as disclosed herein. In all of the modular embodiments disclosed herein, the present invention is also directed to a non-modular unitary pan holder that is adapted to hold a desired number of pans (etc., 2, 3, 4 or more)

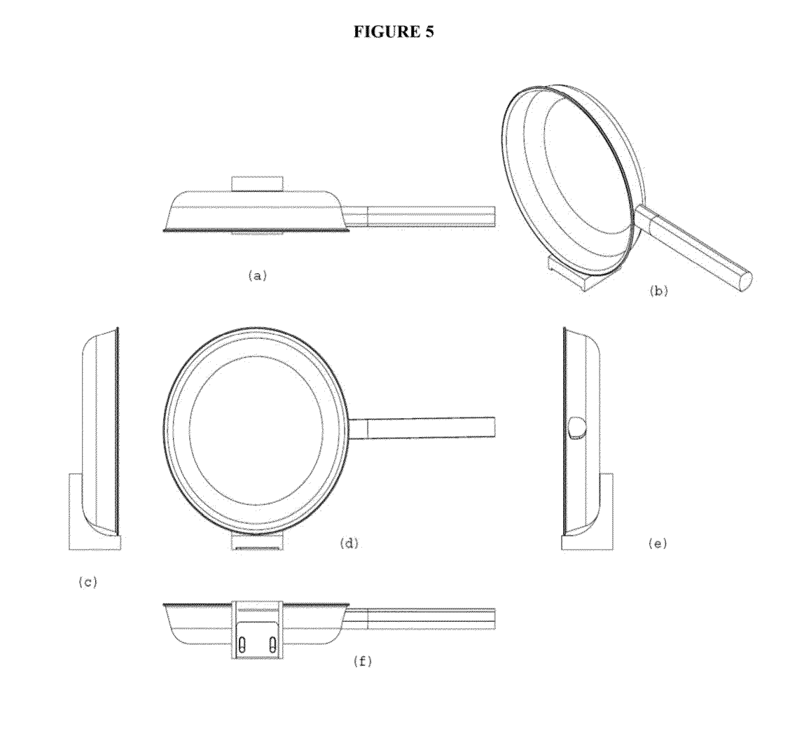

FIG. 5 shows a variety of views from all directions of an exemplary single pan in a single open modular cell according to an exemplary embodiment of the present invention. Thus, FIG. 5(a) is a top view, and FIG. 5(b) is a perspective left side view looking into the interior of the pan. FIG. 5(c) is a rear view, FIG. 5(d) a right side view without perspective, showing the exterior bottom surface of the pan. FIG. 5(e) is a front view with the pan handle positioned at a 3 o'clock orientation, unlike the manner it would generally be stored, as is shown in FIG. 1. Finally, FIG. 5(f) is a bottom view showing the modular structural element and its bottom surface and showing the pan as oriented in it.

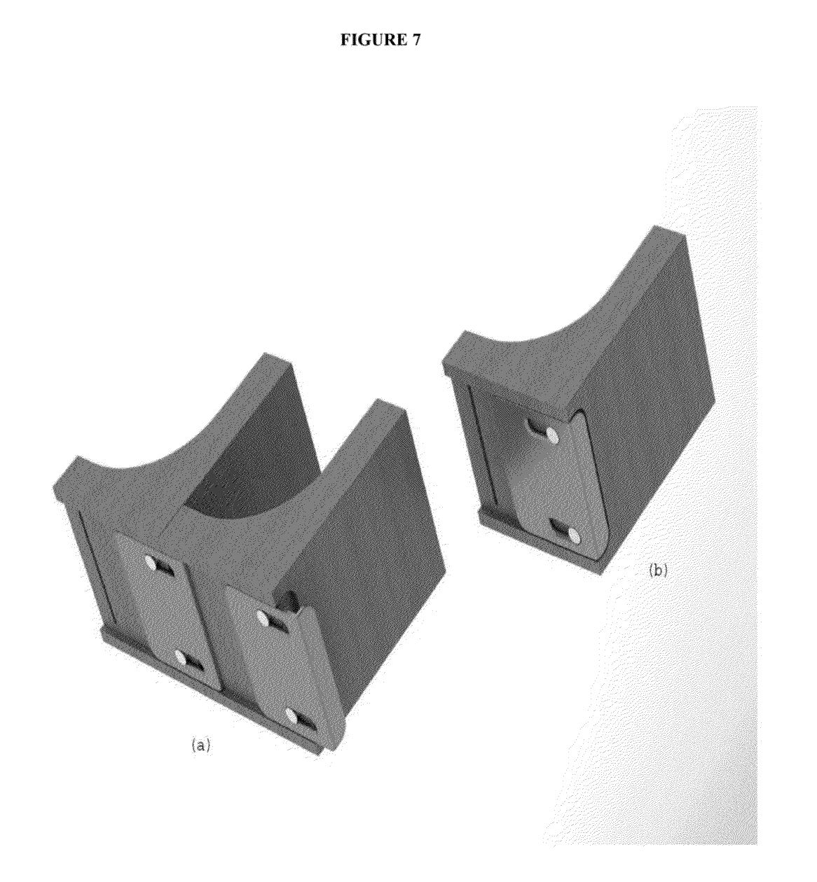

FIG. 6 shows various views of a two modular element combination similar to that rendered in FIG. 4(b). With reference to FIG. 6(a), one can see that the movable metallic plate on the bottom of the structural element on the left has been pulled back so as to fit within a groove near the left edge, or leading edge, of the modular structural element on the right. This illustrates how respective modular structural elements are connected one to the other, and is explained in greater detail with reference to FIG. 7 below. FIG. 6(b) shows the same structure as shown FIG. 6(a) without the detail of the clasping mechanisms on the bottom. FIG. 6(c) is a rear perspective view showing the clasping mechanism of the rightmost modular structural element being fully pushed in, as it is the end piece and is not being used to connect to, or to be inserted into a groove of an adjacent structural element. FIG. 6(d) is a side perspective view similar to that of FIG. 6(a). It is noted that in FIGS. 6(a) and 6(d) the groove in the leftmost element is empty, and the grove of the rightmost element is filled. Additionally, the clasping mechanism of the right most element is in its compressed or collapsed state. As disclosed herein, the attachment of modular units of the present invention can be by any means (e.g., with embedded magnets).

FIG. 7 shows one embodiment of how the modular structural elements connect. FIGS. 7(a) and 7(b) are renderings of the objects shown schematically in FIGS. 6(a) and 6(d). As shown in FIG. 7(a), the left most element has its slide pan, or clasping mechanism, slid backwards to its rear most position so that the vertical lip at the rear end of the slide pan can fit into a groove in the rightmost structural element. Also shown is the rightmost structural element with its slide pan fully extended rearward in a state that will allow it to connect to a third modular structural element to be placed to its right. FIG. 7(b) shows a configuration of the last modular element in a chain, which will thus not connect to an additional structural element to its right and therefore its slide pan is closed and pushed to its foremost position, as shown.

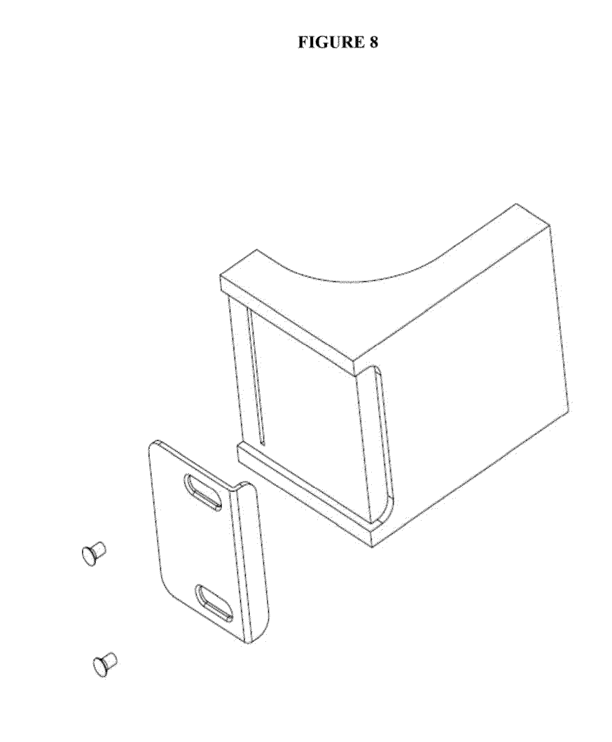

Finally, FIG. 8 is an exploded view of the modular structural element shown in FIG. 7(b) showing the rivets inserted within an elongated oval hole (and then attached to the underside of the device) which thus allows the slide pan to slide rearward. As seen in FIG. 7(b), the rivets can, for example, be inserted into the underside of the device in a line, at a distance from the left edge of the underside surface such that when closed, the slide pan fits precisely into a groove of the vertical right side of the modular element, and when fully open, the rivets keep the slide pan at the correct distance so that its rear lip fits precisely into the groove of the next structural element.

Because all structural elements can be made identical as regards all dimensions except for the radius of curvature of the transition from horizontal to vertical, as described above (so as to accommodate various types and shapes of pans, if desired) the distance between the left end of the device and the groove, as well as the distance between the line containing the rivets and the groove of the next rightmost element, can all be fixed.

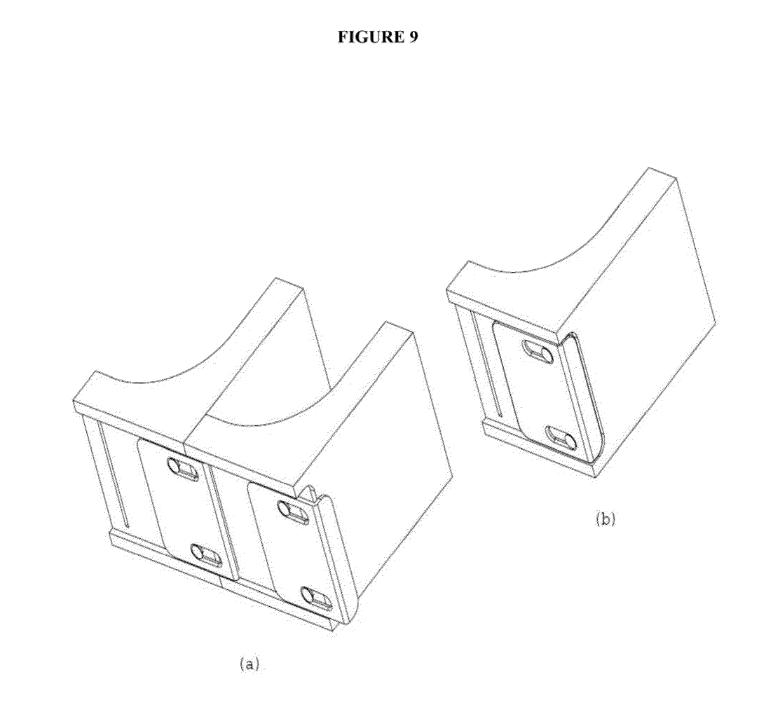

FIG. 9 is a schematic drawing of the renderings of FIG. 7 and is otherwise identical in all functional respects.

### Cookware Stand Attachable to Handles—for Nonmagnetic Cookware

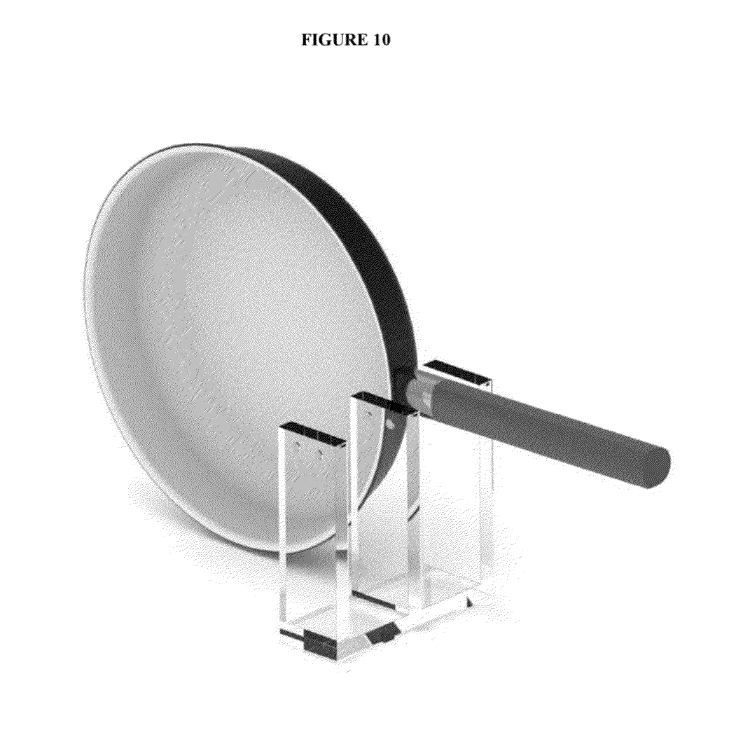

Next described, with reference to FIGS. 10 through 12 is an alternate exemplary embodiment of a magnetic cookware stand according to the present invention. Similar to the structure of FIGS. 1 through 9, this stand or pan holder can be modular or can be manufactured in either two cell, three cell, four cell, etc. versions that are not independently configurable by a user. As can be seen in FIG. 10, this particular embodiment (as well as all other embodiments disclosed herein) may be made out of a transparent substance, such as, for example, plexiglass, acrylic, polycarbonate or some other transparent plastic, fiber or the like. In a particular embodiment, instead of having its bottom arranged so as to fit the contour of the bottom of a pan, the pan is not anticipated to rest within the bottom of the cell but rather to rest on a nearby surface such as, for example, the bottom surface of a drawer, pantry, cupboard, closet, etc. Thus, what holds the pans or other stored cookware in place is the set of magnets embedded on the upper right side of each cell which are designed to attach to a ferromagnetic handle in an otherwise non-ferromagnetic pan, as clearly seen for the open cell in FIG. 10, and as seen on the leftmost outer surface. Therefore, cookware and pans which have no ferromagnetic components except for a small band on their handle, can be stored in the exemplary stand. Although in the illustrated embodiment, the embedded magnets are in one single line, at the same height, in exemplary embodiments of the present invention various rows or arrays of embedded magnets can be provided, so as to accommodate cookware of varying shapes, diameters and sizes. Also, the magnets can be embedded on both sides of the vertical component to have additional points of attachment for further pans.

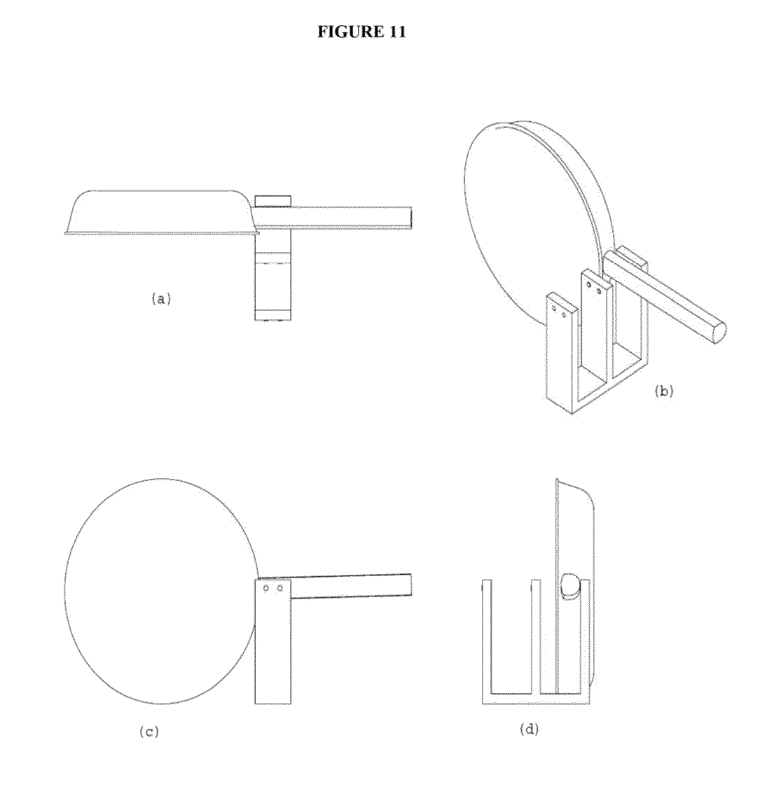

FIG. 11 shows a variety of views of the exemplary cookware stand of FIG. 10, as next described. FIG. 11(a) shows a top view of the pan being held with its handle at an approximate 3 o'clock position within one cell of an exemplary two cell stand. FIG. 11(b) is a perspective left side view looking into the interior of the pan, and FIG. 11(c) is a right side view showing the bottom surface of the pan. It is noted that in this exemplary embodiment as well, there is room for an additional pan at the left most end of the structure, as there are provided embedded magnets on the leftmost outer surface of the exemplary stand. Thus, actually three separate pans can be stored in the shown apparatus. Finally, FIG. 1 (d) is a pure front view of the view shown in FIG. 11(b).

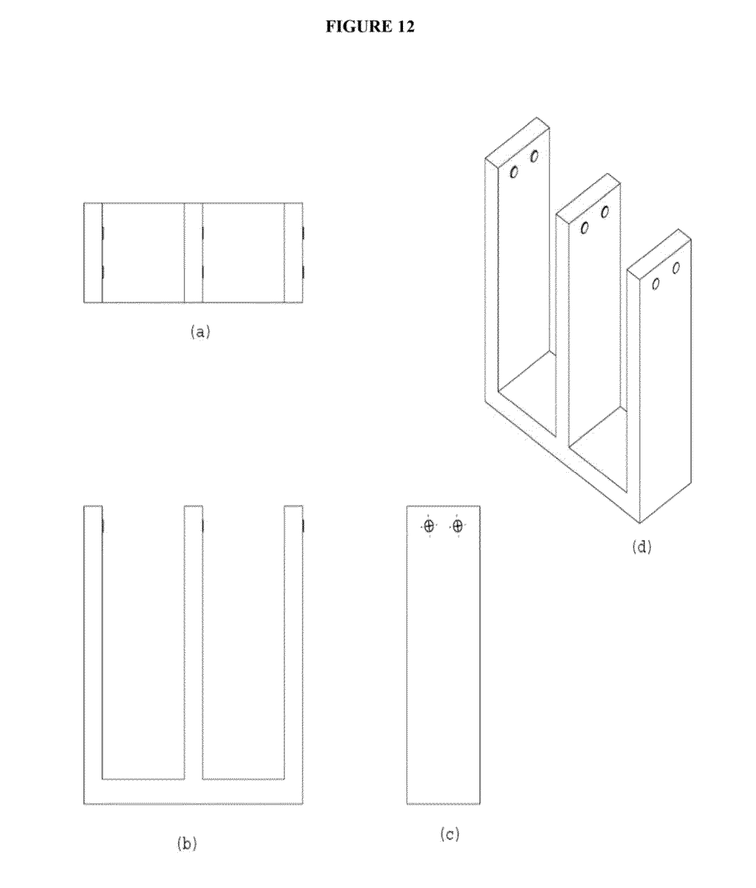

FIG. 12 show additional details of the exemplary stand of FIGS. 10 and 11 without any pan to obscure the view. The device of FIG. 12(a) is that of FIG. 10 rotated 180 degrees about the central column, such that the embedded magnets now appear on the left side of each cell. FIG. 12(a) is a top view, and FIG. 12(b) is a front view of the same device. FIG. 12(c) is a right side view, showing the embedded magnets on the right most vertical upright. Finally, FIG. 12(d) is a perspective front view of the exemplary structure. Thus, as in the case of the exemplary embodiment of FIGS. 1-3, although there are only two full cells in this device, it can actually hold three pans because of the embedded magnets on the outside of the rightmost vertical upright of the device. As previously disclosed, this embodiment can also have additional magnets of the opposite sides of the vertical portions to hold additional pans. In certain embodiments, the space between the vertical components can be expanded to provide sufficient placement of multiple pans

In exemplary embodiments of the present invention, there can be any array of magnets embedded in each side panel of the structure, or for example, a continuous bar magnet, or a magnetized plate, or the like.

In general, it is noted, pans are not ferromagnetic, being often made of aluminum, or copper. Some pans, for example, made from stainless steel or cast iron, are ferromagnetic, and as a result they can be held in an exemplary cookware holder by the embedded magnets attaching to any portion of the bottom flat surface of the pan and not requiring being held in place by the pan handle, which is, in general, often the only ferromagnetic portion of the pan.

In similar fashion as described above for adding ferromagnetic properties to the bottom surfaces of cookware, an analogous process can be performed for non-ferromagnetic cookware handles, thus facilitating the storage of such cookware in the exemplary cookware stand of the disclosed embodiments. In exemplary embodiments of the present invention, an embedded ferromagnetic surface can, for example, be embedded within, glued, riveted or otherwise fastened to a cookware handle, thus allowing it to attach to a magnet in a cookware stand. Such a surface can be, for example, a sheet or ring of stainless steel or other ferromagnetic material.

FIG. 13 shows an alternative embodiment comprising a vertical component containing magnets for engaging a pan and at least one base extending perpendicular to stabilize the vertical component upright in position to engage one or more pans. In the depicted embodiment, there are two bases, one at the anterior of the vertical component and one at the posterior of the vertical component. In certain embodiments, the bases are positioned in an angular arrangement in order to engage the curvature of the pan and to support its weight, as not to have the magnets of the vertical component supporting the full weight of the engaged pan. In the depicted embodiment, in addition to magnets arranged to engage the pan, there are magnets embedded at the ends of the bases in order to engage further modular units in a linear arrangement. The magnets that are used in one modular unit can engage a magnet in another modular unit or can engage a non-magnetic metal surface or embedded metal material in another modular unit. The use of magnets as opposed to braces, clips, etc., facilitates the engagement and removal of modular units by the user.

The magnetic connections can be either visible on the surface of the modular unit or embedded within the modular unit such that it is invisible. In some embodiments utilizing transparent materials, the magnetic connection can be fully embedded yet visible given the transparency of the base material.

The magnetic connections can be incorporated into the modular units such that they are planar with the surrounding material. In other embodiments, the magnetic connections can be incorporated into the modular units such that one connection protrudes and engages with a cavity in another modular unit. The planar or protrusion embodiments can be present in both visible and invisible magnetic connection embodiments.

The present invention is also directed to the magnetic connections disclosed herein without limitation to utilization with pan holders. The magnetic connections disclosed herein may be used to connect any two articles (e.g., modular kitchen organizers).

In the depicted embodiment, the vertical component is trapezoidal. However, any geometric shape can be used to engage the pans.

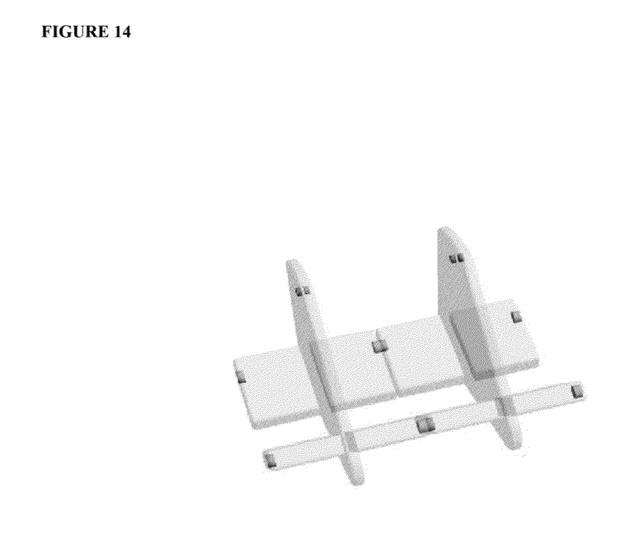

FIG. 14 depicts to engaged modular units as disclosed in FIG. 13. In the depicted arrangement, two modular units allow for the engagement of four pans.

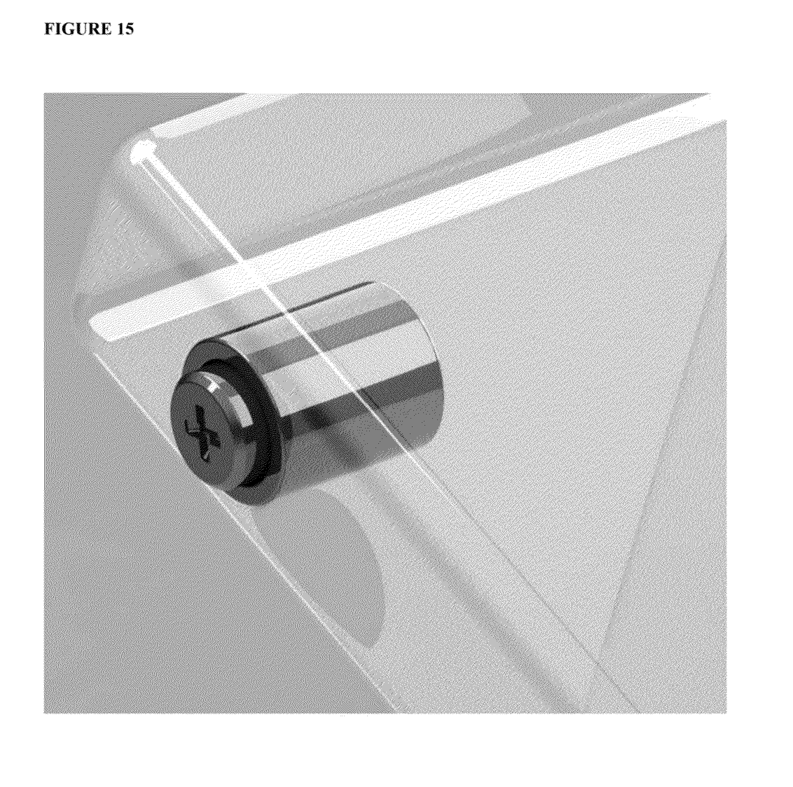

One embodiment utilizes a magnetic connection which is a screw design. In the embodiment depicted in FIG. 15, a casing (e.g., a cylinder with internal treads) is embedded into the modular unit. A magnetic material with external treads can engage the cylindrical base be in position to connect with another modular unit. The embodiment in FIG. 15 protrudes and may engage another unit with a cavity. In certain embodiments, the screw design magnet can engage another magnet or a non-magnetic material of another modular unit.

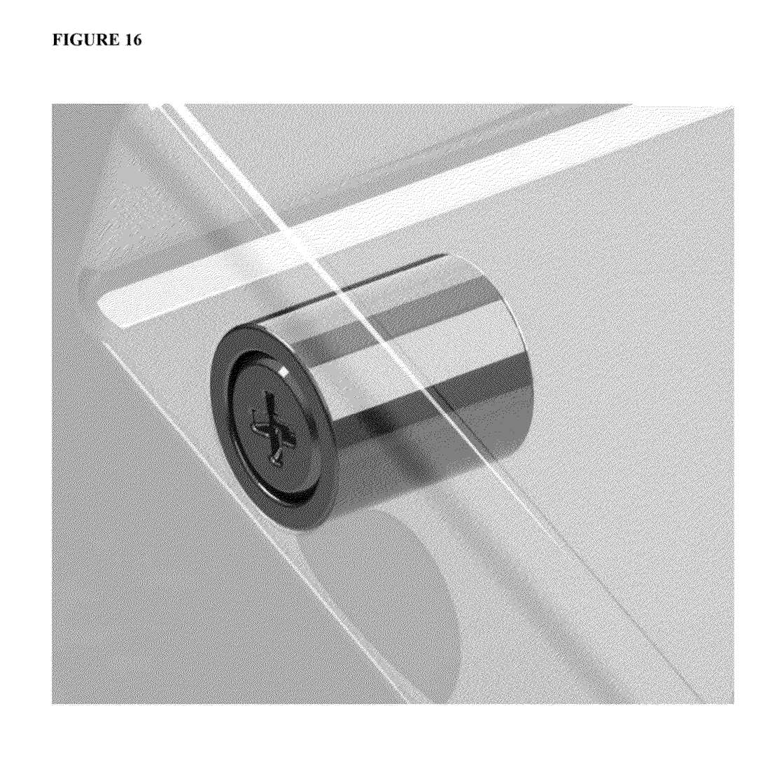

FIG. 16 depicts an alternative embodiment of a screw design magnetic connection wherein the magnetic material is planar with the surface of the surrounding material. As with the screw design of FIG. 15, a casing (e.g., a cylinder with internal treads) is embedded into the modular unit and a magnetic material with external treads engages the cylindrical base be in position to connect with another modular unit. In certain embodiments, the planar screw design magnet can engage another magnet or a non-magnetic material of another modular unit.

In certain embodiments, the invention is directed to the screw design magnetic connections disclosed herein without limitation to the specific articles of manufacture that are attached.

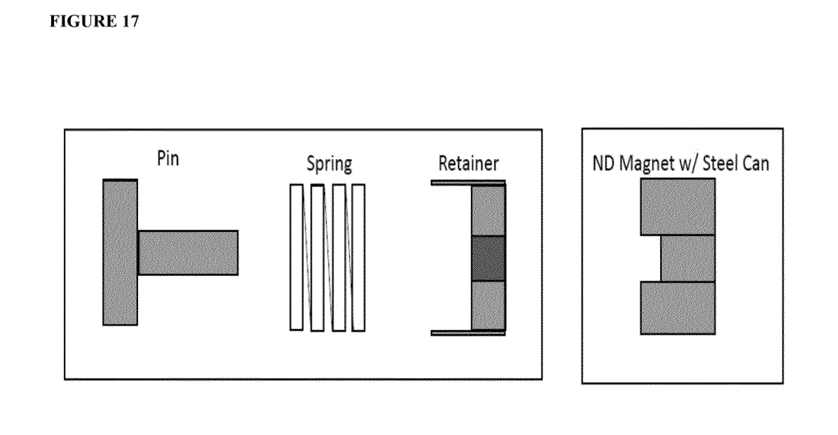

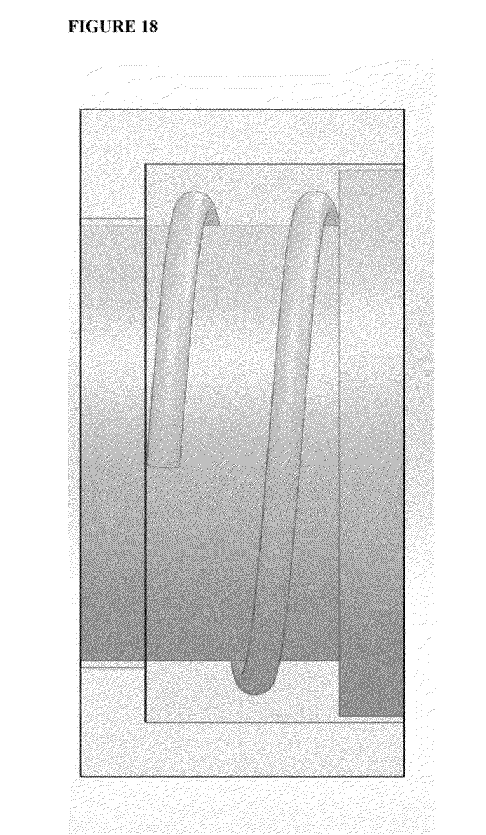

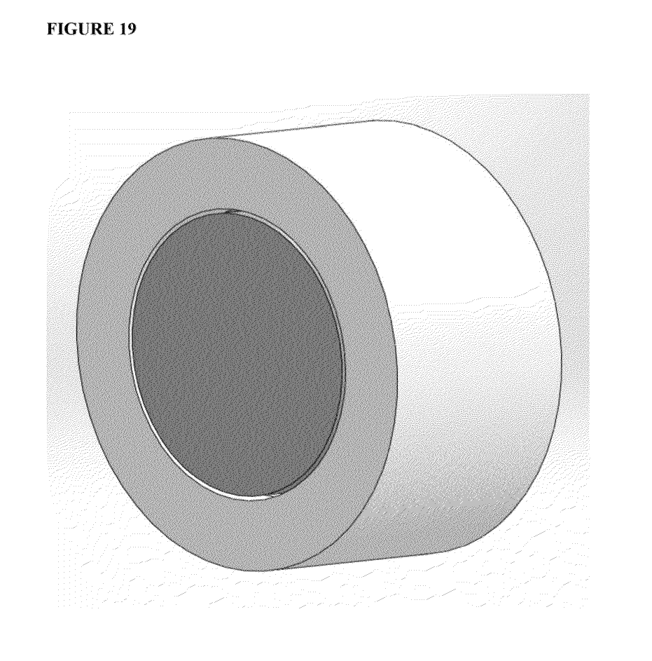

As depicted in FIG. 17, the magnetic connection can be in the form of a spring loaded pin. In this embodiment, the pin with a magnetic head is engaged with a spring and held within a retaining vessel that is embedded in the module. In certain embodiments, the arrangement provides the magnetic connection with give to facilitate the attachment of the individual modules. In other embodiments, the spring loaded magnetic pin is in a first position to engage another module and snaps into a second position to disengage the modules. The spring and/or the retainer can be any suitable polymer or metal. FIG. 18 depicts the magnetic pin engaged with the spring. FIG. 19 depicts the spring loaded peg engaged with and planar to the retainer.

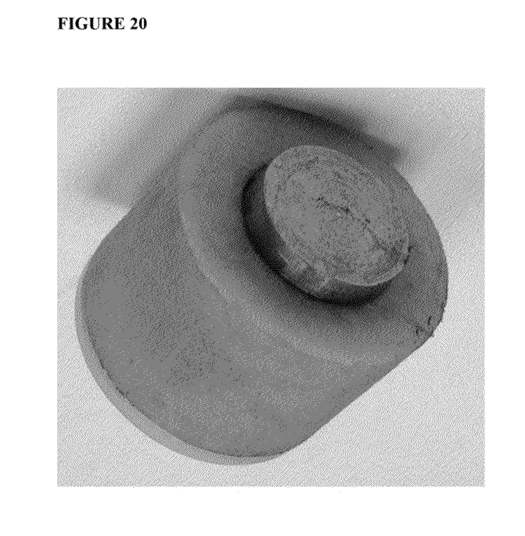

The magnetic connection can also be in the form of a slidable dowel that is engaged in a retainer embedded in a module as depicted in FIG. 20. At least the end of the dowel that faces outward is made of a magnetic material. The embedded end of the dowel and/or the retainer can be made of a self lubricating/low friction material (e.g., polypropylene or Deirin) to reduce jamming. In certain embodiments, the magnetic end of the dowel can be a protrusion to mate with a cavity of another module. In other embodiments, the magnetic end of the dowel is planar with the surface of the module. The dowel and/or the engaged surface of the other module can contain a magnetic surface.

It is also noted that in order to allow a hot pan or article of cookware to be directly stored in the exemplary magnetic storage structures described above, a thin film or covering can be provided on top of the magnets (or other magnetic bar, plate, etc., as noted above) that are embedded in the storage structure, so as to thermally insulate the magnets from the heat of a hot pan, and thus insure that the magnets do not lose their magnetism due to overheating. Such a covering can be any material with a high thermal insulation value, such as, for example, glass, ceramic, or the like. For example, the magnets can be dipped in molten material, or a piece of such material can be glued or adhered to them. Such materials can include, for example, silicone, micro-porous silica, ceramics, or a glass ceramic, such as, for example, Macor™, provided by Corning Incorporated. Such covering can be provided so as to not substantially affect the magnetic field felt by the pan or pan handle, as the case may be, but so as to thermally insulate the magnets from overheating.

Additionally, it is noted, exemplary cookware stands can be made so that the magnets that hold the cookware in place, but do not bear the load of supporting their weight. This is the case in the exemplary embodiments shown in FIGS. 1-2 and 10 and 13-14, for example. To further facilitate this feature, in exemplary embodiments of the present invention bottom or vertical surfaces of exemplary cookware stands, can, for example, be keyed to interlock with pans, either a surface of a pan, or a pan handle, where the interlocking mechanism holds the weight of the cookware as opposed to the magnets. Such an interlocking mechanism can be, for example, a small protrusion at the bottom or side surface of a pan and a corresponding female hole on the side or bottom of a holder, or a protrusion or hole on a pan handle and a corresponding hole or protrusion, respectively on a vertical surface of a cookware stand.

In exemplary embodiments of the present invention, the magnets provided in a storage device (e.g., to hold pans or join modular units) can be at least one of neodymium magnets, rare earth magnets, ceramic magnets, samarium cobalt magnets and AlNiCo magnets. The magnets can be embedded in a surface, as described above, or, for example, in alternate exemplary embodiments, can be long enough to extend through the length of an entire structural element of an exemplary cookware stand, and thus, for example, provide magnetic capability to both sides of a structural member, if desired. Alternatively, two magnets can be utilized on each side without the need for a single elongated magnetic material.

In certain embodiments, the cookware stands may be manufactured by first creating a thermoplastic outer shell by injection molding or heat extrusion. A skilled artisan would recognize the injection molding techniques required to form a hollowed article, such as those, e.g., described in U.S. Pat. No. 5,098,637, or the heat extrusion techniques, such as those described in U.S. Pat. No. 6,368,547, the contents of which are hereby incorporated by reference.

The cavity of the hollowed stand may then be filled with a resin or epoxy, preferably a resin or epoxy that is malleable at room temperature, thus no heated process is required for the internal cavity.

In certain embodiments, when the thermoplastic mold is formed and filled with the resin or epoxy, minimal or no seams are present in the cookware stand.

In certain embodiments, an internal liner may be inserted between the inner surface of the outer shell and the inner core of the cookware stand. In such embodiments, the internal liner is inserted into the hollow cavity prior to filling the cavity with the resin or epoxy. The internal liner is useful when the materials used to fabricate the outer shell are not compatible with the resin/epoxy used to fill the inner cavity.

In certain embodiments, the material used for the outer shell of the cookware stand is a thermoplastic resin suitable for injection molding, such as, e.g., polycarbonate homopolymers, copolycarbonates, acrylonitrile-butadiene-styrene resins (ABS), styrene/acrylonitrile (SAN), polyamides, thermoplastic polyurethane, polymethylmethacrylate (PMMA Acrylics), thermoplastic urethane (TPU), Thermoplastic Elastomer (TPE), polyvinyl fluoride (PVF), poly vinylidine fluoride (PVDF), blends of polycarbonate, resins thereof, or combinations or mixtures thereof.

In certain embodiments, the material used for the inner cavity is any type of resin which can be used at room temperature, e.g., acrylic or epoxy resin or any combination or mixture thereof. The acrylic resin can be, e.g., polymethyl acrylate or polymethyl methacrylate. The epoxy resin can be, e.g., either glycidyl epoxy (e.g., glycidyl-ether, glycidyl-ester and glycidyl-amine) or non-glycidyl epoxy resins (e.g., aliphatic or cycloaliphatic epoxy resins).

In preferred embodiments of the present invention, the materials used will result in a clear or substantially clear cookware stand. However, in other embodiments, the materials can result in an opaque or even colored article if an opaque or colored cookware stand is desired. To achieve an opaque or colored cookware stand, the resin may contain a dye or suitable pigment to render to desired color or level of opacity.

In certain embodiments, the outer shell can be treated with an ultraviolet light resistant additive to prevent discoloration (e.g., yellowing). The additive can be provided as a topcoat or incorporated into the mold material. Typical additives include benzophenones and can be present in an amount, e.g., from about 0.01% to about 10% or about 0.05% to about 5% or about 1% to about 2%, based on weight.

In certain embodiments the resin added to the cavity needs additional cooling, e.g., when the cavity is greater than about 3 inches squared. The additional cooling can be by subjecting the filled product to cool air (e.g., by refrigeration or by a cool airstream). In other embodiments, the additional cooling can be by an extended time at ambient temperatures.

The above-presented description and figures are intended by way of example only and are not intended to limit the present invention in any way except as set forth in the following claims. It is particularly noted that persons skilled in the art can readily combine the various technical aspects of the various elements of the various exemplary embodiments that have been described above in numerous other ways, all of which are considered to be within the scope of the invention.

What is claimed is:

1. A modular cookware storage apparatus, comprising:
at least one structural element, the structural element comprising:
a vertical component; and
a base component perpendicular to the vertical component;
wherein the vertical component is embedded with one or more magnets,
wherein the structural element is provided with a magnetic interconnection mechanism, with which it can be removably attached to another structural element.

2. The modular cookware storage apparatus of claim 1, wherein at least two structural elements are attached together via said magnetic interconnection mechanism.

3. The modular cookware storage apparatus of claim 1, wherein the magnetic interconnection mechanism is selected from the group consisting of a screw design, a spring loaded pin design and a slidable dowel design.

4. The modular cookware storage apparatus of claim 1, wherein the one or more magnets are one of an array of magnets and a bar magnet.

5. The modular cookware storage apparatus of claim 1, wherein said magnets are at least one of neodymium magnets, rare earth magnets, ceramic magnets, samarium cobalt magnets and AlNiCo magnets.

6. The modular cookware storage apparatus of claim 4, wherein said magnets are at least one of neodymium magnets, rare earth magnets, ceramic magnets, samarium cobalt magnets and AlNiCo magnets.

7. The modular cookware storage apparatus of claim 1, wherein the one or more embedded magnets are covered with a thermo-insulating film or cover.

8. The modular cookware storage apparatus of claim 7, wherein said film or cover is made from at least one of silicone, micro-porous silica, glass, ceramic and glass-ceramic.

9. The modular cookware storage apparatus of claim 7, wherein the thermo-insulating cover does not substantially diminish the magnetic field of said magnets.

10. The modular cookware storage apparatus of claim 1, wherein said vertical component comprises a curved upper surface arranged to substantially match the contour of a piece of cookware placed in the apparatus with its diameter in a vertical orientation.

11. The modular cookware storage apparatus of claim 1, wherein said one or more magnets are provided at different heights along said vertical component.
